(19) United States
(12) Patent Application Publication
(10) Pub. No.: US 2014/0145958 A1
(43) Pub. Date: May 29, 2014

(54) TABLET COMPUTER ASSEMBLY, ACCESSORY THEREOF, AND TABLET COMPUTER INPUT METHOD

(71) Applicants: INVENTEC (PUDONG) TECHNOLOGY CORPORATION, Shanghai (CN); INVENTEC CORPORATION, Taipei City (TW)

(72) Inventors: Caroline ZHANG, Shanghai (CN); Wen LI, Shanghai (CN); Jockey LI, Shanghai (CN)

(73) Assignees: Inventec Corporation, Taipei City (TW); Inventec (Pudong) Technology Corporation, Shanghai (CN)

(21) Appl. No.: 13/776,674

(22) Filed: Feb. 25, 2013

(30) Foreign Application Priority Data
Nov. 27, 2012 (CN) 201210491304.3

(51) Int. Cl. G06F 3/03

(52) U.S. Cl. CPC G06F 3/03
USPC 345/168

(57) ABSTRACT

A tablet computer assembly is provided and includes a tablet computer and an accessory. The tablet computer has a display screen and a first connection portion. The accessory has a second connection portion. The second connection portion is configured for pivoting on the first connection portion of the tablet computer, such that the tablet computer and the accessory are selectively separated or integrated as a single piece. The accessory is rotated relative to the tablet computer, and rotates along an axis direction which is the extending direction of the second connection portion. The accessory has a virtual keyboard forming device located on a surface of the accessory, and the virtual keyboard forming device is to form a keyboard image having a plurality of virtual keys. The keyboard image is displayed on a bearing surface.

### RELATED APPLICATIONS

This application claims priority to China Application Serial Number 201210491304.3, filed Nov. 27, 2012, which is herein incorporated by reference.

### BACKGROUND

1. Field of Invention

The present invention relates to a tablet computer assembly, an accessory thereof, and a method for inputting keyboard instruction to a tablet computer.

2. Description of Related Art

Currently, portable electronic devices, such as the personal digital assistant (PDA), smart phone and tablet computer, have flourished in the market of various consumer electronic products. When using the electronic devices with a touch screen, users can input instructions directly through the touch screen instead of keys, which enables the electronic devices to be more humanized.

Generally, the screen size of the portable electronic devices is limited by the consideration of the volume and weight thereof. Moreover, when words are inputted by using a touch screen, a virtual keyboard shown on the screen will occupy about half of the display area, making it inconvenient for users to input words quickly. Therefore, some electronic devices are provided with connection ports, so that the users can use the connection ports to connect other external input devices. When a large number of words need to be inputted into the portable electronic devices, users can utilize the connection ports (such as USB, PS/2, Bluetooth and other interfaces) of the electronic devices optionally to connect an external physical keyboard, so as to make it convenient for inputting words quickly.

However, the advantage of the portable electronic devices lies in that the portable electronic devices can be used as users move to different places. If it is required to carry the portable electronic devices along with the physical keyboards for inputting words conveniently, it will cause an increase in the volume and weight, and will still cause inconvenience for users.

### SUMMARY

An aspect of the present invention is to provide a tablet computer assembly.

According to an embodiment of the present invention, a tablet computer assembly includes a tablet computer and an accessory. The tablet computer has a display screen disposed on a first front surface and a first connection portion disposed on a first lateral surface of the tablet computer. The accessory is configured for pluggable assembled the tablet computer and has a second connection portion disposed on a second lateral surface of the accessory. The second connection portion is configured for pivoting on the first connection portion of the tablet computer, such that the tablet computer and the accessory are selectively separated or integrated as a single piece. The accessory is rotated relative to the tablet computer, and rotates along an axis direction which is the extending direction of the second connection portion. a first usage state, the first lateral surface of the tablet computer and the second lateral surface of the accessory are all matched and overlapped with each other. In a second usage state, the accessory is rotated relative to the tablet computer, and rotates along the axis direction which is the extending direction of the second connection portion. The accessory has a fixed rotation angle according to the tablet computer. The tablet computer assembly is fixedly positioned on a bearing surface at the fixed rotation angle. The accessory has a virtual keyboard forming device located on a second front surface of the accessory, and the virtual keyboard forming device is to form a keyboard image having a plurality of virtual keys. The keyboard image is displayed on the bearing surface.

In an embodiment of the present invention, the virtual keyboard forming device includes a keyboard projection component, a light sensor, a light emitter and a control unit. The light emitter is on the same side with the keyboard projection component and the light sensor. The first front surface and the second front surface are on the same side. The control unit is electrically connected with the light sensor.

In an embodiment of the present invention, the second connection portion mentioned above is a second data transmission connection portion. The first connection portion is a first data transmission connection portion. The second data transmission connection portion includes a hinge structure configured for the accessory relatively rotating on the tablet computer and having the fixed rotation angle according to the tablet computer. The second data transmission connection portion further includes a data transmission line used for transmitting data from the tablet computer to the accessory.

In an embodiment of the present invention, the accessory mentioned above further includes an image projection component. The image projection component is on an opposite side to the virtual keyboard forming device. When the tablet computer and the accessory are integrated, the first data transmission connection portion is connected with the second data transmission connection portion, thereby transmitting data from an image of the tablet computer display screen to the image projection component through the data transmission line, so as to project the image of the display screen onto an image projection surface.

In an embodiment of the present invention, the accessory mentioned above further includes a battery component used to sustain the battery capacity of the tablet computer.

In an embodiment of the present invention, the first lateral surface of the tablet computer and the second lateral surface of the accessory mentioned above have the same size and shape, and the first connection portion is pivotally connected at a central position of the first lateral surface of the tablet computer, and the second connection portion is pivotally connected at a central position of the second lateral surface of the accessory.

In an embodiment of the present invention, in the second usage state mentioned above, an end of the tablet computer and an end of the accessory are abutted against the bearing surface, and a distance exists between the two ends of the tablet computer and the accessory.

An aspect of the present invention is to provide an accessory configured for pluggable assembled a tablet computer. The tablet computer has a display screen disposed on a first front surface and a first connection portion disposed on a first lateral surface of the tablet computer.

According to an embodiment of the present invention, an accessory includes a second connection portion and a virtual keyboard forming device. The second connection portion is disposed on a second lateral surface of the accessory and is configured for pivoting on the first connection portion of the tablet computer, such that the tablet computer and the tablet computer accessory are selectively separated or integrated as a single piece. The tablet computer accessory is rotated relative to the tablet computer, and rotates along an axis direction which is the extending direction of the second connection portion. In a first usage state, the first lateral surface of the tablet computer and the second lateral surface of the accessory are matched and overlapped with each other. in a second usage state, the accessory is rotated relative to the tablet computer, and rotates along the axis direction which is the extending direction of the second connection portion. The accessory has a fixed rotation angle according to the tablet computer. The virtual keyboard forming device is disposed on a second front surface of the accessory. The virtual keyboard forming device is to form a keyboard image having a plurality of virtual keys. The keyboard image is displayed on a bearing surface.

An aspect of the present invention is to provide a method for inputting keyboard instruction to a tablet computer.

According to an embodiment of the present invention, a method for inputting keyboard instruction to a tablet computer includes the following steps:
(a) providing a tablet computer assembly having a tablet computer and an accessory;
(b) pivoting a second connection portion of the accessory on a first connection portion of the tablet computer;
(c) rotating the accessory relative to the tablet computer, wherein the accessory rotates along an axis direction which is the extending direction of the second connection portion, and has a fixed rotation angle according to the tablet computer;
(d) positioning the tablet computer assembly onto a bearing surface;
(e) forming a keyboard image having a plurality of virtual keys by using a keyboard projection component of a virtual keyboard forming device of the accessory, wherein the keyboard image is displayed on the bearing surface;
(f) emitting a light onto the keyboard image by using a light emitter of the virtual keyboard forming device;
(g) pressing at least one of the virtual keys on the bearing surface to block the light emitted on the pressed virtual key; and
(h) sensing a blocked position of the light with a light sensor of the virtual keyboard forming device and transmitting a pressing signal to a control unit of the virtual keyboard forming device, such that the control unit controls a display screen of the tablet computer to display a corresponding image according to the pressing signal.

In an embodiment of the present invention, the tablet computer input method mentioned above further includes the following steps: rotating the accessory relative to the tablet computer, wherein the accessory has the fixed rotation angle according to the tablet computer by using a hinge structure of the second connection portion; and transmitting data from the tablet computer to the tablet computer accessory by using a data transmission line of the second connection portion.

In an embodiment of the present invention, the tablet computer input method mentioned above further includes the following step: projecting an image of the display screen onto an image projection surface by using an image projection component of the accessory.

In the embodiments of the present invention mentioned above, since the accessory is rotatably and detachably connected to the tablet computer, the tablet computer assembly can be fixedly positioned on a bearing surface when the accessory is rotated relative to the tablet computer and has a fixed rotation angle according to the tablet computer. When being used, the keyboard projection component of the virtual keyboard forming device can form a keyboard image having a plurality of virtual keys on the bearing surface and the light emitter of the virtual keyboard forming device can emit a light onto the keyboard image. When the virtual keys of the keyboard image are pressed, the light emitted on the pressed keys will be blocked. At this time, the light sensor of the virtual keyboard forming device can sense the blocked position of the light and transmit the pressing signal to the control unit of the virtual keyboard forming device. Then, the control unit can control the display screen to display the corresponding image according to the pressing signal.

The tablet computer assembly can be used to input words with the keyboard image of the bearing surface and the keyboard image will not occupy the area of the tablet computer display screen, which enables users to input words quickly. In addition, the tablet computer assembly has the input function of a physical keyboard without being connected to a physical keyboard externally. In other words, no physical keyboard is required when users carry a tablet computer assembly, thereby saving the volume and weight of the physical keyboard.

### BRIEF DESCRIPTION OF THE DRAWINGS

FIG. 1 illustrates a perspective view of a tablet computer assembly according to an embodiment of the present invention;

FIG. 2 illustrates an exploded view of the tablet computer assembly shown in FIG. 1;

FIG. 3 illustrates a perspective view of the tablet computer assembly shown in FIG. 1 when it is used;

FIG. 4 illustrates a schematic view from a direction D when a keyboard image shown in FIG. 3 is pressed;

FIG. 5 illustrates a perspective view of a tablet computer assembly according to an embodiment of the present invention;

FIG. 6 illustrates a schematic view of the tablet computer assembly shown in FIG. 5 when it is used and

FIG. 7 illustrates a flow chart of a method for inputting keyboard instruction to a tablet computer according to an embodiment of the present invention.

### DETAILED DESCRIPTION

A plurality of embodiments of the present invention are disclosed below with reference to the drawings. For the purpose of clear illustration, various practical details will be illustrated along with other things in the description below. However, it should be understood that the present invention is not limited to these practical details. In other words, in some embodiments of the present invention, these practical details are unnecessary. Furthermore, for the purpose of simplifying the drawings, some conventional common structures and elements are illustrated in the drawings in a simply schematic manner.

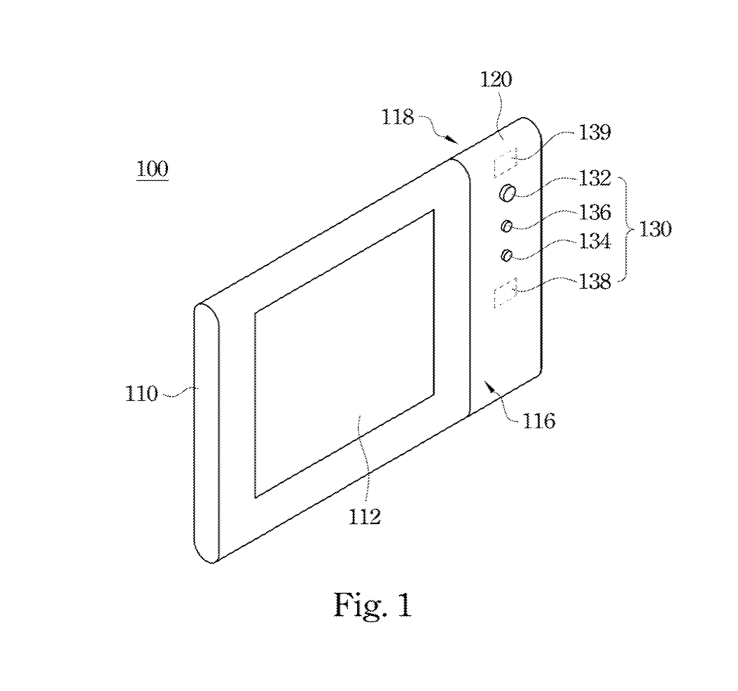

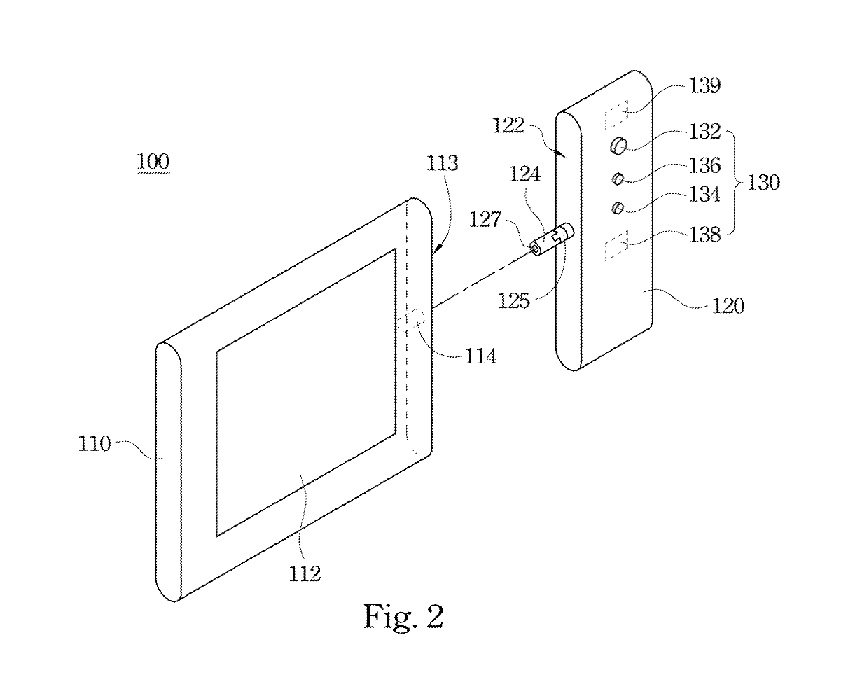

FIG. 1 illustrates a perspective view of a tablet computer assembly 100 according to an embodiment of the present invention. FIG. 2 illustrates an exploded view of the tablet computer assembly 100 shown in FIG. 1. Referring both to FIGS. 1 and 2, the tablet computer assembly 100 includes a tablet computer 110 and an accessory 120. The tablet computer 110 has a display screen 112 disposed on a first front surface and a first connection portion 114 disposed on a first lateral surface 113 of the tablet computer 110. The accessory 120 is configured for pluggable assembled the tablet computer 110, and has a second connection portion 124 disposed on a second lateral surface 122 of the accessory 120. The second connection portion 124 is configured for pivoting on the first connection portion 114 of the tablet computer 110, such that the tablet computer 110 and the accessory 120 are selectively separated or integrated as a single piece.

In a first usage state, the first lateral surface 113 of the tablet computer 110 and the second lateral surface 122 of the accessory 120 are matched and overlapped with each other, as shown in FIG. 1. In this embodiment, the adjacent surfaces (i.e., the first and second lateral surfaces 113, 122) of the tablet computer 110 and the accessory 120 have the same size and shape, and the first connection portion 114 is pivotally connected at a central position of the first lateral surface 113 of the tablet computer 110 and the second connection portion 124 is pivotally at a central position of the second lateral surface 122 of the accessory 120.

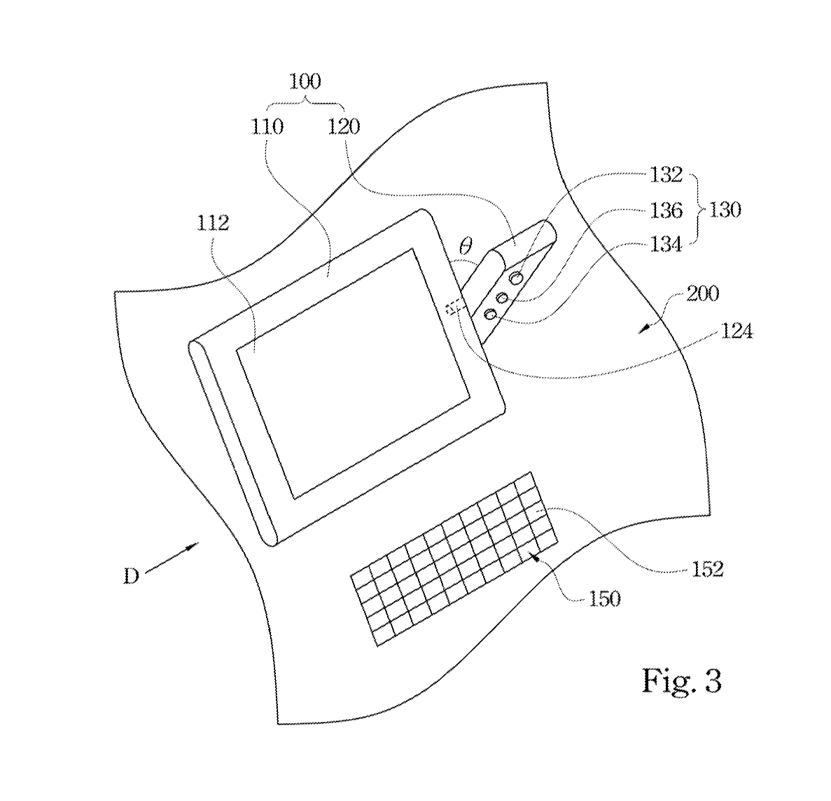

FIG. 3 illustrates a perspective view of the tablet computer assembly 100 shown in FIG. 1 when it is used. Referring both to FIGS. 2 and 3, the tablet computer accessory 120 can be rotated relative to the tablet computer 110, and rotates along an axis direction which is the extending direction of the second connection portion 124. When the tablet computer assembly 100 shown in FIG. 3 is in a second usage state, the accessory 120 is rotated relative to the tablet computer 110 by the second connection portion 124 and has a fixed rotation angle θ according to the tablet computer 110. The tablet computer assembly 100 can be fixedly positioned on a bearing surface 200 at the fixed rotation angle θ, and the fixed rotation angle θ can be, for example, 30-60 degrees, but the range of the fixed rotation angle θ does not limit the present invention.

In this embodiment, the second connection portion 124 and the first connection portion 114 can be regarded as a second data transmission connection portion and a first data transmission connection portion respectively. The second data transmission connection portion can include a hinge structure 125 configured for the accessory 120 rotating relative to the tablet computer 110 and having the fixed rotation angle θ according to the tablet computer 110. The second data transmission connection portion can further include a data transmission line 127 used for transmitting data from the tablet computer 110 to the tablet computer accessory 120. In other embodiments, the first connection portion 114 and the second connection portion 124 can selectively include a hinge structure, a latch or a clamping slot without limiting the present invention, as long as the accessory 120 can be pivotally and detachably connected to the tablet computer 110

In addition, a virtual keyboard forming device 130 is located on a second front surface of the accessory 120, and the virtual keyboard forming device 130 is to form a keyboard image 150 having a plurality of virtual keys 152. The keyboard image 150 is on the bearing surface 200. The first and second front surfaces are on the same side 116. In this embodiment, the virtual keyboard forming device 130 includes a keyboard projection component 132, a light sensor 134, a light emitter 136 and a control unit 138. The display screen 112 of the tablet computer 110 and the keyboard projection component 132, the light sensor 134 and the light emitter 136 of the virtual keyboard forming device 130 are located on the same side 116, and the control unit 138 is electrically connected with the light sensor 134. Furthermore, the accessory 120 can further include a battery component 139 capable of sustaining the battery capacity of the tablet computer 110.

The functions of the tablet computer 110, such as webpage browsing, video playing, music, photograph, game playing and application execution, can be used independently. The accessory 120 can be separated from the tablet computer 110 to use the tablet computer 110 independently when the virtual keyboard forming device 130 is not used. Alternatively, the accessory 120 is connected with the tablet computer 110, but the fixed rotation angle θ is 0 degree. In this state (i.e., the first usage state), the tablet computer assembly 100 is still convenient for carrying.

In the following description, the virtual keyboard forming device 130 when being used will be described.

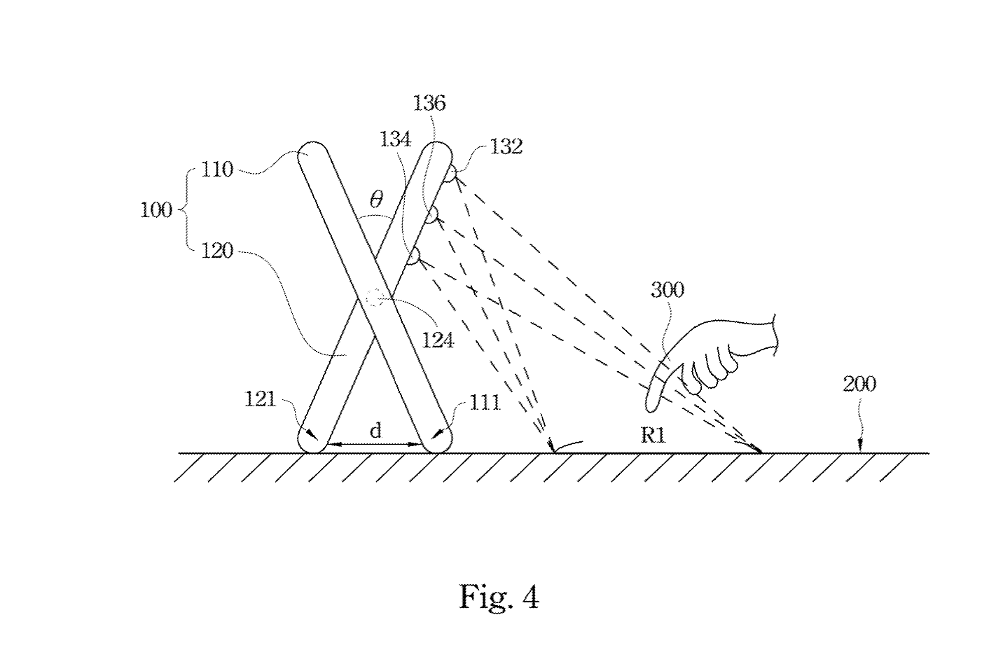

FIG. 4 illustrates a schematic view from a direction D when the keyboard image 150 shown in FIG. 3 is pressed. Referring both to FIGS. 3 and 4, the tablet computer assembly 100 shown in FIGS. 3 and 4 is in the second usage state. In this state, an end 111 of the tablet computer 110 and an end 121 of the accessory 120 can be abutted against the bearing surface 200 and a distance d exists between the end 111 of the tablet computer 110 and the end 121 of the accessory 120. Since the distance d exists between the end 111 of the tablet computer 110 and the end 121 of the accessory 120, the tablet computer assembly 100 can be fixedly positioned on the bearing surface 200 at the fixed rotation angle θ.

When being used, the keyboard projection component 132 of the virtual keyboard forming device 130 can form a keyboard image 150 having a plurality of virtual keys 152 on the bearing surface 200. In this embodiment, the bearing surface 200 is the same surface where the tablet computer assembly 100 is positioned. The light emitter 136 can emit lights onto the keyboard image 150. When at least one of the virtual keys 152 is pressed on the bearing surface 200 by a finger 300, the light emitted on the pressed key 152 is blocked by the finger 300. The light sensor 134 can sense a blocked position of the light and transmit a pressing signal of the pressed virtual key 152 to the control unit 138 (referring to FIG. 2), thereby enabling the control unit 138 to control the display screen 112 to display a corresponding image according to the pressing signal.

For example, when the finger 300 presses the key “V” of the keyboard image 150, the light sensor 134 can sense that the light emitted on the key “V” is blocked, and transmit the pressing signal of the key “V” to the control unit 138 (referring to FIG. 2), such that the control unit 138 controls the display screen 112 to display the image of “V” according to the pressing signal.

In this embodiment, the keyboard projection component 132 projects the keyboard image 150 with a projection range R1 onto the bearing surface 200, and the sensing range of the light sensor 134 covers at least the light emitted in the projection range R1. In this embodiment, the light given off by the light emitter 136 can be an infrared light, and the light sensor 134 can be a sensor capable of sensing the infrared light, but the kind of the light shall not be limited to the infrared light.

In particularly, since the accessory 120 can be pivotally and detachably connected to the tablet computer 110, the tablet computer assembly 100 can be fixedly positioned on the bearing surface 200 when the accessory 120 is rotated relative to the tablet computer 110 and is fixed at the fixed rotation angle θ according to the tablet computer 110. When being used, the keyboard projection component 132 of the virtual keyboard forming device 130 can form the keyboard image 150 having a plurality of virtual keys 152 on the bearing surface 200 and the light emitter 136 of the virtual keyboard forming device 130 can emit a light onto the keyboard image 150. When the keys 152 of the keyboard image 150 are pressed, the light emitted on the pressed keys 152 will be blocked. At this time, the light sensor 134 of the virtual keyboard forming device 130 can sense the blocked position of the light and transmit the pressing signal to the control unit 138 of the virtual keyboard forming device 130 (referring to FIG. 2). Then, the control unit 138 can control the display screen 112 to display the corresponding image according to the pressing signal.

The tablet computer assembly 100 can be used to input words with the keyboard image 150 of the bearing surface 200 and the keyboard image 150 does not occupy the area of the display screen 112 of the tablet computer 110, which enables users to input words quickly. In addition, the tablet computer assembly 100 has the input function of a physical keyboard without being connected to a physical keyboard externally. In other words, no physical keyboard is required when users carry the tablet computer assembly 100, thereby saving the volume and weight of the physical keyboard.

It is noted to be that the components and the component connection relation which have been described in the embodiments mentioned above will not be illustrated again. In the description below, other components that can be included in the tablet computer assembly 100 will be illustrated.

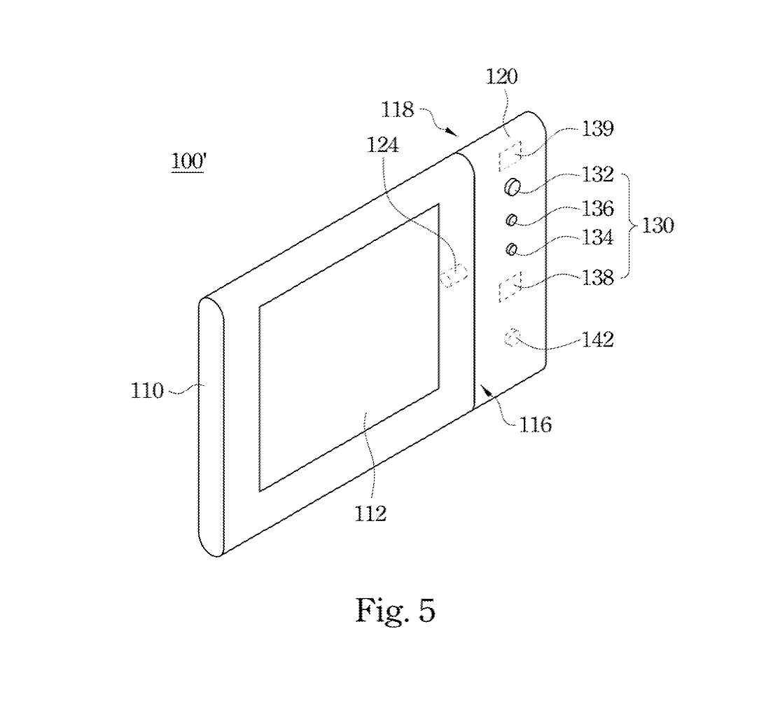

FIG. 5 illustrates a perspective view of a tablet computer assembly 100′ according to an embodiment of the present invention. The tablet computer assembly 100′ includes a tablet computer 110 and an accessory 120. The difference from the embodiment in FIG. 1 is: the accessory 120 further includes an image projection component 142. In this embodiment, the image projection component 142 is on an opposite side to the virtual keyboard forming device 130. That is, the image projection component 142 is on a side 118 and the keyboard projection component 132 is on a side 116.

Referring both to FIGS. 2 and 5, when the tablet computer 110 is integrated with the accessory 120, the second connection portion 124 and the first connection portion 114 can be regarded as a second data transmission connection portion and a first data transmission connection portion respectively. The first data transmission connection portion is connected with the second data transmission connection portion, thereby transmitting the data of the image of the display screen 112 of the tablet computer 110 to the image projection component 142 through the data transmission line 127.

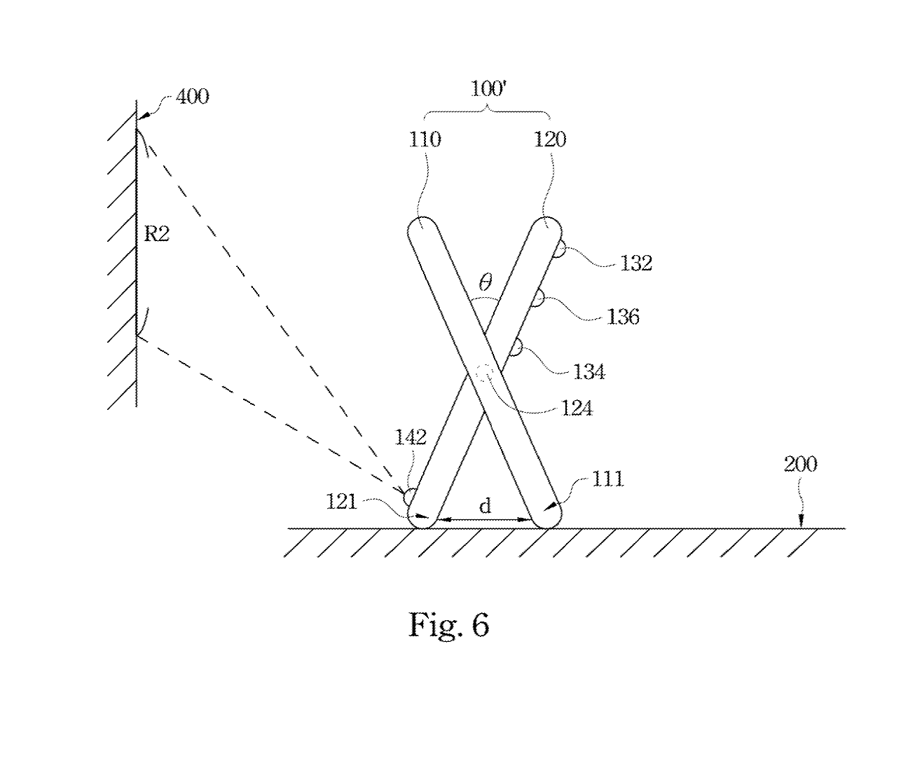

FIG. 6 illustrates a schematic view of the tablet computer assembly 100′ shown in FIG. 5 when it is used. Referring both to FIGS. 5 and 6, the image projection component 142 can project the image of the display screen 112 onto an image projection surface 400 according to the image data of the display screen 112 of the tablet computer 110. The image projection component 142 projects the image of the display screen 112 onto the image projection surface 400 with a projection range R2. In this embodiment, the image projection surface 400 may be a projection curtain or a wall, which does not limit the present invention.

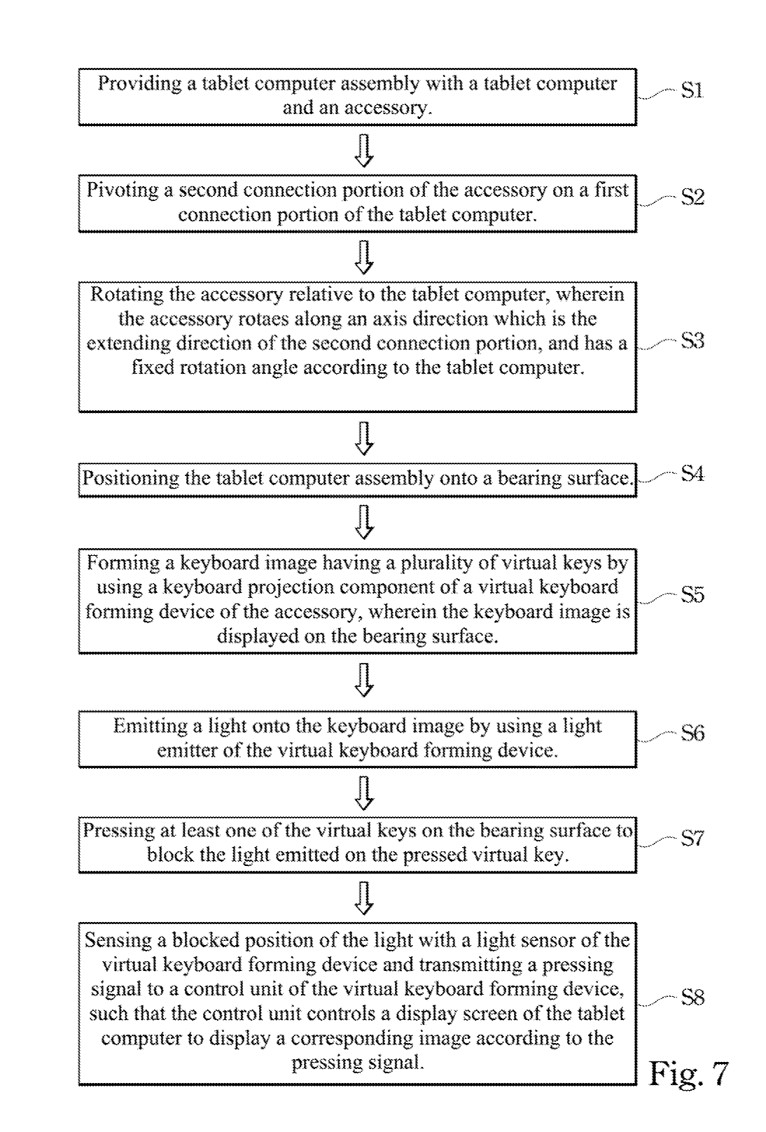

FIG. 7 illustrates a flow chart of a method for inputting keyboard instruction to a tablet computer according to an embodiment of the present invention. The tablet computer input method includes the following steps: at first, in step S1, providing a tablet computer assembly with a tablet computer and an accessory; then, in step S2, pivoting a second connection portion of the accessory on a first connection portion of the tablet computer; next, in step S3, rotating the accessory relative to the tablet computer, wherein the accessory rotates along an axis direction which is the extending direction of the second connection portion, and has a fixed rotation angle according to the tablet computer; then, in step S4, positioning the tablet computer assembly onto a bearing surface; next in step S5, forming a keyboard image having a plurality of virtual keys by using a keyboard projection component of a virtual keyboard forming device of the accessory, wherein the keyboard image is displayed on the bearing surface; then, in step S6, emitting a light onto the keyboard image by using a light emitter of the virtual keyboard forming device; next, in step S7, pressing at least one of the virtual keys on the bearing surface to block the light emitted on the pressed virtual key; at last, in step S8, sensing a blocked position of the light with a light sensor of the virtual keyboard forming device and transmitting a pressing signal to a control unit of the virtual keyboard forming device, such that the control unit controls a display screen of the tablet computer to display a corresponding image according to the pressing signal.

In addition, the tablet computer input method can further include the following steps: rotating the accessory relative to the tablet computer, wherein the accessory has the fixed rotation angle according to the tablet computer by using a hinge structure of the second connection portion; transmitting the data of the tablet computer to the tablet computer accessory by using a data transmission line of the second connection portion; projecting an image of the display screen onto an image projection surface by using an image projection component of the accessory.

Comparing the embodiments mentioned above of the present invention with the prior art, the tablet computer assembly can be used to input words with the keyboard image of the bearing surface and the keyboard image does not occupy the area of the host display screen, which enables users to input words quickly. In addition, the tablet computer assembly has the input function of a physical keyboard without being connected to a physical keyboard externally. In other words, no physical keyboard is required when users carry a tablet computer assembly, thereby saving the volume and weight of the physical keyboard.

Although the present invention has been disclosed with reference to the above embodiments, these embodiments are not intended to limit the present invention. It will be apparent to those of skills in the art that various modifications and variations can be made without departing from the spirit and scope of the present invention. Therefore, the scope of the present invention shall be defined by the appended claims.

What is claimed is:

1. A tablet computer assembly comprising:
a tablet computer having a display screen disposed on a first front surface and a first connection portion disposed on a first lateral surface of the tablet computer; and
an accessory which is configured for pluggable assembled the tablet computer and has a second connection portion disposed on a second lateral surface of the accessory, wherein the second connection portion is configured for pivoting on the first connection portion of the tablet computer, such that the tablet computer and the accessory are selectively separated or integrated as a single piece, and the accessory is rotated relative to the tablet computer, and rotates along an axis direction which is the extending direction of the second connection portion; in a first usage state, the first lateral surface of the tablet computer and the second lateral surface of the accessory are matched and overlapped with each other: in a second usage state, the accessory is rotated relative to the tablet computer, and rotates along the axis direction which is the extending direction of the second connection portion, and has a fixed rotation angle according to the tablet computer, and the tablet computer assembly is fixedly positioned on a bearing surface at the rotation angle, and the accessory comprises a virtual keyboard forming device disposed on a second front surface of the accessory, and the virtual keyboard forming device is to form a keyboard image having a plurality of virtual keys, wherein the keyboard image is displayed on the bearing surface.

2. The tablet computer assembly of claim 1, wherein the virtual keyboard forming device comprises:
a keyboard projection component;
a light sensor;
a light emitter which is on the same side with the keyboard projection component and the light sensor, wherein the first front surface and the second front surface are on the same side; and
a control unit electrically connected with the light sensor, wherein the light emitter is used to emit a light onto the keyboard image, and when at least one of the keys is pressed on the bearing surface, the light emitted on the pressed key is blocked, and the light sensor senses a blocked position of the light and transmits a pressing signal to the control unit, such that the control unit controls the display screen to display a corresponding image according to the pressing signal.

3. The tablet computer assembly of claim 1, wherein the second connection portion is a second data transmission connection portion, and the first connection portion is a first data transmission connection portion; the second data transmission connection portion comprises a hinge structure and a data transmission line, wherein the hinge structure is configured for the accessory rotating relative to the tablet computer and having the fixed rotation angle according to the tablet computer, and the data transmission line is used for transmitting data from the tablet computer to the accessory.

4. The tablet computer assembly of claim 3, wherein the accessory further comprises:
an image projection component positioned on a side opposite to the virtual keyboard forming device, wherein when the tablet computer and the accessory are integrated, the first data transmission connection portion is connected with the second data transmission connection portion, thereby transmitting data from an image of the tablet computer display screen to the image projection component through the data transmission line, so as to project the image of the display screen onto an image projection surface.

5. The tablet computer assembly of claim 1, wherein the accessory further comprises a battery component used to sustain a battery capacity of the tablet computer.

6. The tablet computer assembly of claim 1, wherein the first lateral surface of the tablet computer and the second lateral surface of the accessory have the same size and shape, and the first connection portion is pivotally connected at a central position of the first lateral surface of the tablet computer, and the second connection portion is pivotally connected at a central position of the second lateral surface of the accessory.

7. The tablet computer assembly of claim 1, wherein in the second usage state, an end of the tablet computer and an end of the accessory are abutted against the bearing surface, and a distance exists between the two ends of the tablet computer and the accessory.

8. An accessory, configured for pluggable assembled a tablet computer which has a display screen disposed on a first front surface and a first connection portion disposed on a first lateral surface of the tablet computer, wherein the accessory comprises:
a second connection portion disposed on a second lateral surface of the accessory, which is configured for pivoting on the first connection portion of the tablet computer, such that the tablet computer and the accessory are selectively separated or integrated as a single piece, and the accessory is rotated relative to the tablet computer, and rotates along an axis direction which is the extending direction of the second connection portion, in a first usage state, the first lateral surface of the tablet computer and the second lateral surface of the accessory are matched and overlapped with each other; and in a second usage state, the accessory is rotated relative to the tablet computer, and rotates along the axis direction which is the extending direction of the second connection portion, and has a fixed rotation angle according to the tablet computer, the tablet computer and the accessory are integrally and fixedly positioned on a bearing surface at the rotation angle; and
a virtual keyboard forming device disposed on a second front surface of the accessory, wherein the virtual keyboard forming device is to form a keyboard image having a plurality of virtual keys, and the keyboard image is displayed on the bearing surface.

9. The accessory of claim 8, wherein the virtual keyboard forming device comprises:
a keyboard projection component;
a light sensor;
a light emitter which is on the same side with the keyboard projection component and the light sensor, wherein the first front surface and the second front surface are on the same side; and
a control unit electrically connected with the light sensor, wherein the light emitter is used to emit a light onto the keyboard image, and when at least one of the keys is pressed on the bearing surface, the light emitted on the pressed key is blocked, and the light sensor senses a blocked position of the light and transmits a pressing signal to the control unit, such that the control unit controls the display screen to display a corresponding image according to the pressing signal.

10. The accessory of claim 8, wherein the second connection portion is a second data transmission connection portion and the first connection portion is a first data transmission connection portion; the second data transmission connection portion comprises a hinge structure and a data transmission line, wherein the hinge structure is configured for the accessory rotating relative to the tablet computer and having the fixed rotation angle according to the tablet computer, and the data transmission line is used for transmitting data from the tablet computer to the accessory.

11. The accessory of claim 10, wherein the accessory further comprises:
an image projection component positioned on a side opposite to the virtual keyboard forming device, wherein when the tablet computer and the accessory are integrated, the first data transmission connection portion is connected with the second data transmission connection portion, thereby transmitting data from an image of the tablet computer display screen to the image projection component through the data transmission line, so as to project the image of the display screen onto an image projection surface.

12. The accessory of claim 8, wherein in the second usage state, an end of the tablet computer and an end of the accessory are abutted against the bearing surface, and a distance exists between the two ends of the tablet computer and the accessory.

13. A method for inputting keyboard instruction to a tablet computer, comprising:
(a) providing a tablet computer assembly having a tablet computer and an accessory;
(b) pivoting a second connection portion of the accessory on a first connection portion of the tablet computer;
(c) rotating the accessory relative to the tablet computer, wherein the accessory rotates along an axis direction which is the extending direction of the second connection portion, and has a fixed rotation angle according to the tablet computer;
(d) positioning the tablet computer assembly onto a bearing surface;
(e) forming a keyboard image having a plurality of virtual keys by using a keyboard projection component of a virtual keyboard forming device of the accessory, wherein the keyboard image is displayed on the bearing surface;
(f) emitting a light onto the keyboard image by using a light emitter of the virtual keyboard forming device;
(g) pressing at least one of the virtual keys on the bearing surface to block the light emitted on the pressed virtual key; and
(h) sensing a blocked position of the light with a light sensor of the virtual keyboard forming device and transmitting a pressing signal to a control unit of the virtual keyboard forming device, such that the control unit controls a display screen of the tablet computer to display a corresponding image according to the pressing signal.

14. The tablet computer input method of claim 13, further comprising:
rotating the accessory relative to the tablet computer, wherein the accessory has the fixed rotation angle according to the tablet computer by using a hinge structure of the second connection portion; and
transmitting the data of the tablet computer to the accessory by using a data transmission line of the second connection portion.

15. The tablet computer input method of claim 13, further comprising:
projecting an image of the display screen onto an image projection surface by using an image projection component of the accessory.
